(19) United States
(12) Patent Application Publication
(10) Pub. No.: US 2025/0001784 A1
(43) Pub. Date: Jan. 2, 2025

(54) PRINTER

(71) Applicant: BROTHER KOGYO KABUSHIKI KAISHA, Nagoya (JP)

(72) Inventors: Shuhei YAMAKAMI, Nagoya (JP); Munetoshi SOMA, Nagoya (JP); Tetsuya ISHIYAMA, Chita (JP); Yuki HIRAMATSU, Nukata (JP); Taiki HASHIZUME, Kariya (JP)

(21) Appl. No.: 18/757,224

(22) Filed: Jun. 27, 2024

(30) Foreign Application Priority Data
Jun. 29, 2023 (JP) 2023-106602

(51) Int. Cl. B41J 29/393; B41J 3/407

(52) U.S. Cl. CPC B41J 29/393; B41J 3/4075

(57) ABSTRACT

A printer configured to be driven by a battery. The printer includes a printing unit, a power delivery unit, a processor, and a memory. The printing unit is configured to perform printing on a medium, based on a power of the battery. The power delivery unit is configured to deliver an output power to an external device. The output power is based on the power of the battery. The memory stores computer-readable instructions that, when executed by the processor, perform processes. The processes include monitoring a remaining charge of the battery, after delivering the output power to the external device by the power delivery unit. The processes include changing the output power to the external device, in accordance with the monitored remaining charge of the battery.

### REFERENCE TO RELATED APPLICATIONS

This application claims priority from Japanese Patent Application No. 2023-106602 filed on Jun. 29, 2023. The entire content of the priority application is incorporated herein by reference.

### BACKGROUND ART

The present disclosure relates to a printer.

A power transmission device is driven using a battery. Based on a power of the battery, the power transmission device decides an output power, which is the power supplied to a power reception device, based on a power of the battery. The power transmission device delivers the decided output power to the power reception device.

### SUMMARY

The above-described power transmission device continues the power delivery with the decided output power even when a remaining charge of the battery decreases. In this case, depending on the remaining charge of the battery, there is a possibility that the power necessary in the power transmission device is not sufficient.

Various embodiments of the general principles described herein provide a printer contribute to secure a necessary power for printing, even when a remaining charge of a battery fluctuates after a start of power delivery to an external device.

Embodiments herein provide a printer configured to be driven by a battery. The printer includes a printing unit, a power delivery unit, a processor, and a memory. The printing unit is configured to perform printing on a medium, based on a power of the battery. The power delivery unit is configured to deliver an output power to an external device. The output power is based on the power of the battery. The memory stores computer-readable instructions that, when executed by the processor, perform processes. The processes include monitoring a remaining charge of the battery, after delivering the output power to the external device by the power delivery unit. The processes include changing the output power to the external device, in accordance with the monitored remaining charge of the battery.

The printer can appropriately control the power delivery of the output power to the external device by changing the output power in accordance with a fluctuation in the remaining battery charge. Thus, the printer can secure a power necessary for printing, even when the remaining charge of the battery fluctuates after the start of the power delivery to the external device.

### BRIEF DESCRIPTION OF DRAWINGS

FIG. 1 is a diagram showing a connection state between a printer and a tablet PC.

FIG. 2 is a block diagram showing an electrical configuration of the printer.

FIG. 3 is a flowchart of main processing.

FIG. 4 is a table showing a power data object (PDO).

FIG. 5 is a flowchart of the main processing according to a modified example.

### DESCRIPTION

An embodiment according to the present disclosure will be described with reference to the drawings. A direction diagonally downward and to the right, a direction diagonally upward and to the left, a direction diagonally upward and to the right, a direction diagonally downward and to the left, an upward direction, and a downward direction are, respectively, a right side, a left side, a rear side, a front side, an upper side, and a lower side of a printer 1.

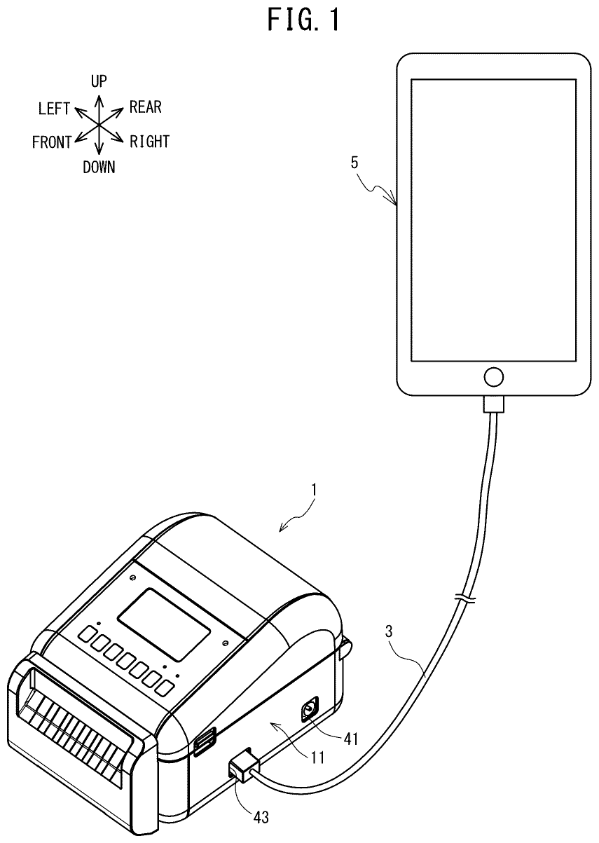

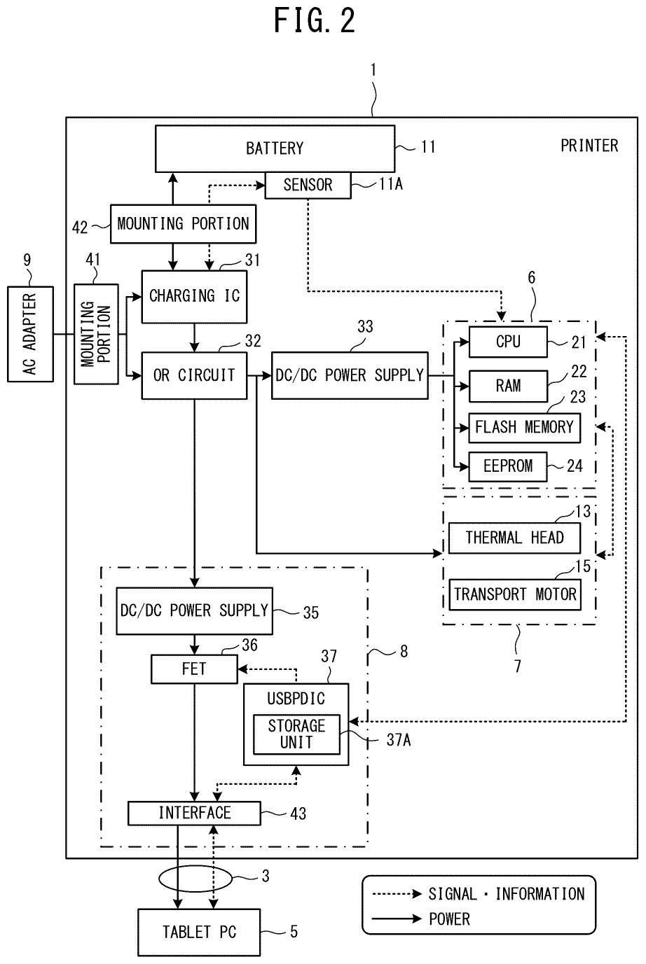

As shown in FIG. 1, the printer 1 is configured to be able to print on a medium for printing. The medium is, for example, a plurality of heat sensitive labels adhered continuously to a long backing sheet. The printer 1 is driven by receiving power supplied from a battery 11. The battery 11 is detachably mounted to a mounting portion 42 (refer to FIG. 2) provided inside the printer 1. The battery 11 is a lithium ion secondary battery, for example. Note that the printer 1 can be driven by receiving power supplied from an external power supply connected to a commercial power supply (not shown in the drawings), for example. The external power supply is an AC adaptor 9 (refer to FIG. 2), for example. The AC adaptor 9 is connected to a mounting portion 41 provided at a lower rear portion of the right side surface of the printer 1.

An interface 43 is provided at a lower front portion of the right side surface of the printer 1. The interface 43 is a USB interface (I/F) compatible with the USB Type-C (registered trademark) standard. A cable 3 is connected to the interface 43. The cable 3 is provided with a connector that is compatible with the USB Type-C standard, and supports USB power delivery (USB PD). The cable 3 can transmit power corresponding to a maximum 5 A current, and transfer various pieces of information, for example.

The printer 1 can be connected to an external device, for example, via the interface 43 and the cable 3. The external device is a tablet PC 5, for example. The tablet PC 5 is provided with an LCD touch panel, for example. A user uses the touch panel to edit print data, such as letters, graphics, and the like, and transmits the print data to the printer 1 via the cable 3. The printer 1 prints, on the medium, characters of the letters, graphics, and the like, based on the print data received from the external device.

Further, the printer 1 can deliver power to the tablet PC 5 in accordance with the USB power delivery (USB PD) standard. In this way, the printer 1 can charge the tablet PC 5.

An electrical configuration of the printer 1 will be described with reference to FIG. 2. The printer 1 is further provided with a charging IC 31, an OR circuit 32, DC/DC power supplies 33 and 35, a digital circuit unit 6, a printing unit 7, a power delivery unit 8, and the like. The charging IC 31 charges the battery 11 mounted to the mounting portion 42, using power from the AC adaptor 9. The battery 11 is provided with a sensor 11A capable of detecting a remaining battery charge. An output result from the sensor 11A is transmitted to a CPU 21. The CPU 21 detects the remaining charge of the battery 11 from the received output result.

The OR circuit 32 switches a power delivery path to the tablet PC 5 in accordance with the presence or absence of a connection with the battery 11 and with the AC adaptor 9. When only the AC adaptor 9 is connected, for example, the OR circuit 32 switches the power delivery path so as to deliver the power from the AC adaptor 9. When only the battery 11 is connected, for example, the OR circuit 32 switches the power delivery path so as to supply power from the battery 11. When the AC adaptor 9 and the battery 11 are connected, for example, the OR circuit 32 switches the power delivery path so as to deliver the power of the battery 11 to the digital circuit unit 6, the printing unit 7, the power delivery unit 8, and the like, while delivering the power of the AC adaptor 9 to the battery 11. Note that when the battery 11 and the AC adaptor 9 are connected to the printer 1, the OR circuit 32 may switch the power delivery path so as to deliver the power of the AC adaptor 9 to the battery 11, and deliver the power from the AC adaptor 9 to the tablet PC 5. In this case, the OR circuit 32 may switch the power delivery path so as to deliver the power from either the battery 11 or the AC adaptor 9 to the digital circuit unit 6, the printing unit 7, the power delivery unit 8, and the like. Note that the switching of the power delivery path by the OR circuit 32 is automatically performed, but a configuration may be adopted in which the power delivery path can be set by the user.

The DC/DC power supply 33 converts an input voltage from the AC adaptor 9 or the battery 11 into an output voltage (3.3 V, for example) for driving the digital circuit unit 6. The digital circuit unit 6 includes the CPU 21, a RAM 22, a flash memory 23, an EEPROM 24, and the like. The CPU 21 performs overall control of the printer 1. The CPU 21 is electrically connected to the RAM 22, the flash memory 23, the EEPROM 24, the printing unit 7, and the power delivery unit 8.

The RAM 22 temporarily stores various data, such as the print data received from the tablet PC 5. The flash memory 23 stores various programs and the like executed by the CPU 21 and a USBPDIC 37 to control the printer 1. The EEPROM 24 stores information, such as printer settings, a print history, and the like.

The power from the AC adaptor 9 and the battery 11 is delivered to the printing unit 7. The printing unit 7 can perform the printing on the medium using the power from the AC adaptor 9 or the battery 11. The printing unit 7 is provided with a thermal head 13 and a transport motor 15. The thermal head 13 generates heat in accordance with a signal from the CPU 21, and performs the printing on the medium. The transport motor 15 drives a feed roller for feeding the medium. The CPU 21 controls the thermal head 13 and the transport motor 15 and performs the printing on the medium.

The power delivery unit 8 is provided with the DC/DC power supply 35, the USBPDIC 37, a FET 36, the interface 43, and the like. The DC/DC power supply 35 converts an input voltage from the AC adaptor 9 or the battery 11 to an output voltage suited for the power delivery to the tablet PC 5 (9 V, 5 V, or the like, for example). Hereinafter, the voltage output by the DC/DC power supply 35 is also referred to as “output power”. The output power is delivered to the tablet PC 5. The USBPDIC 37 can perform mutual communication with the CPU 21. The USBPDIC 37 can control a value of the output voltage from the DC/DC power supply 35. The USBPDIC 37 performs negotiation, via the interface 43, with the tablet PC 5 in compliance with the USB power delivery (USB PD) standard. The USBPDIC 37 controls the delivery of the output power to the tablet PC 5 from the DC/DC power supply 35, by controlling the turning on and off of the FET 36. For example, when the FET 36 is on, the output power is delivered to the tablet PC 5 via the interface 43 and the cable 3. In other words, the power delivery unit 8 can deliver, to the tablet PC 5, the output power, which is the power delivered using the power of the AC adaptor 9 or the battery 11. Note that the USBPDIC 37 is provided with a storage unit 37A and the like. The storage unit 37A stores a power data object (PDO) to be described later.

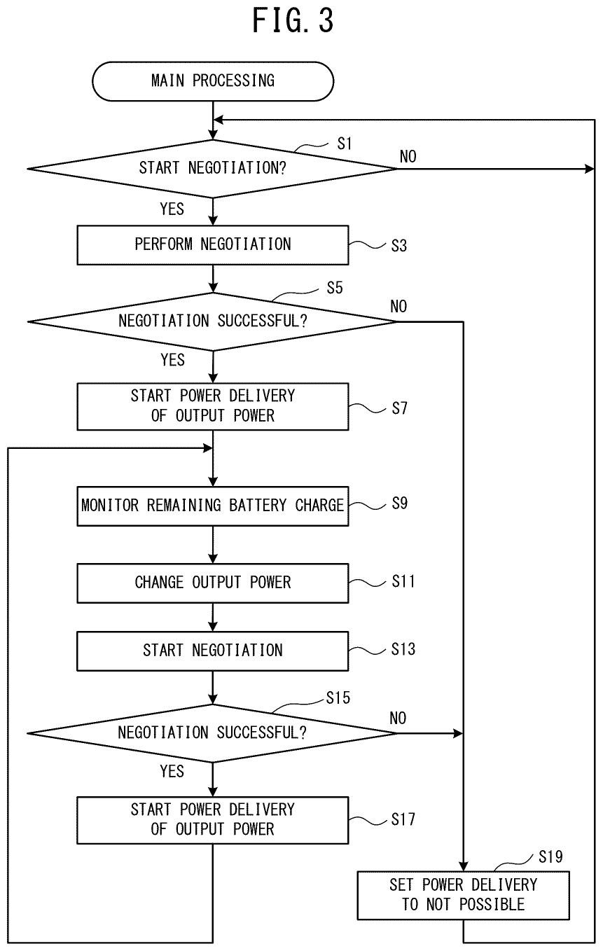

Main processing will be described with reference to FIG. 3. In the following description, a case will be described in which the AC adaptor 9 is not connected to the printer 1, and a case will be separately described in which the AC adaptor 9 is connected to the printer 1. First, the case in which the AC adaptor 9 is not connected to the printer 1 will be described. In this case, the printer 1 is driven using only the power of the battery 11. Since the AC adaptor 9 is not connected, the printer 1 does not perform charging of the battery 11. When the user presses a power button of the printer 1, the USBPDIC 37 reads out and executes a program from the flash memory 23. The USBPDIC 37 starts the main processing in this way.

When the main processing is started, the USBPDIC 37 determines whether or not to start negotiation with the tablet PC 5 (S1). For example, when the USBPDIC 37 detects that the tablet PC 5 is connected to the printer 1, the USBPDIC 37 determines that negotiation is to be started. When it is determined that the negotiation is not to be started (no at S1), the USBPDIC 37 returns the processing to S1 and stands by. When it is determined that the negotiation is to be started (yes at S1), the USBPDIC 37 performs the negotiation with the tablet PC 5 (S3).

The USBPDIC 37 determines whether or not the negotiation has been successful (S5). For example, the USBPDIC 37 decides the success or failure based on whether or not the power delivery unit 8 can deliver the output power required by the tablet PC 5. When it is determined that the negotiation has failed (no at S5), the USBPDIC 37 sets the power delivery of the output power to the tablet PC 5 from the power delivery unit 8 to not possible (S19). In this case, the USBPDIC 37 turns the FET 36 off. In this way, the power delivery of the output power from the DC/DC power supply 35 is disabled. The USBPDIC 37 returns the processing to S1.

When it is determined that the negotiation has been successful (yes at S5), the USBPDIC 37 starts the power delivery of the output power from the power delivery unit 8 to the tablet PC 5 (S7). In this case, the USBPDIC 37 turns the FET 36 on. In this way, the output power is delivered from the DC/DC power supply 35 to the tablet PC 5. For example, the output power delivered by the processing at S7 is equivalent to the power required by the tablet PC 5 by the negotiation performed by the processing at S3. Further, the USBPDIC 37 controls the DC/DC power supply 35 such that a voltage value required by the tablet PC 5 is output. The USBPDIC 37 performs the power delivery of the output power to the tablet PC 5 based on a result of the negotiation.

After starting the power delivery of the output power to the tablet PC 5 by the power delivery unit 8, the USBPDIC 37 monitors the remaining charge of the battery 11 (S9). In this case, the USBPDIC 37 acquires the remaining charge of the battery 11 from the CPU 21. Note that the USBPDIC 37 may monitor the remaining charge of the battery 11 by directly acquiring a detection result of the sensor 11A.

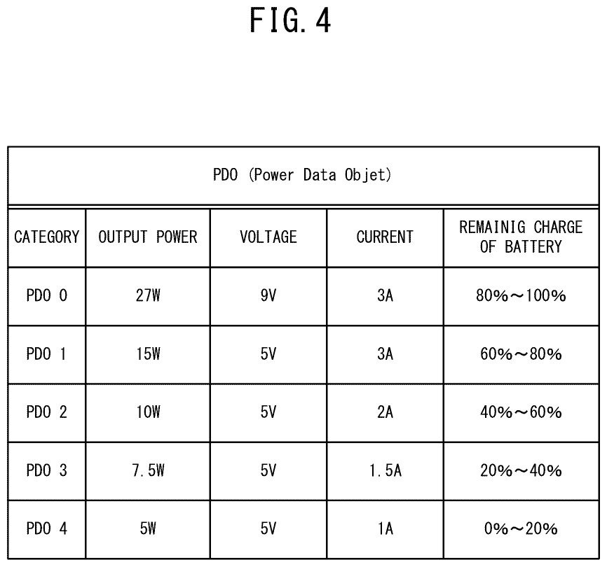

The USBPDIC 37 changes the output power to the tablet PC 5 in accordance with the monitored remaining charge of the battery 11 (S11). In this case, the USBPDIC 37 refers to the power data object (PDO) shown in FIG. 4. The power data object (PDO) indicates the output power that the power delivery unit 8 is able to deliver corresponding to the remaining charge of the battery 11. The power data object (PDO) is an object in which the output power (voltage, current) corresponding to the remaining charge of the battery 11 is categorized into “PDO 0” to “PDO 4”. According to the power data object (PDO), as the remaining charge of the battery 11 decreases, the output power that can be delivered by the power delivery unit 8 is suppressed. For example, when the remaining battery charge is in a range of 80% to 100%, the USBPDIC 37 can select the categories “PDO 0” to “PDO 4”. In this case, the power delivery unit 8 can deliver the output power of a maximum of 27 W. On the other hand, when the remaining battery charge is in a range of 0% to 20%, the USBPDIC 37 can only select the category “PDO 4”. In this case, the power delivery unit 8 can deliver the output power of a maximum of 5 W.

Based on the output power changed at S11, the USBPDIC 37 starts negotiation with the tablet PC 5 (S13). By communication with the power delivery unit 8, the USBPDIC 37 determines whether or not the negotiation has been successful (S15). When it is determined that the negotiation has been successful (yes at S15), the USBPDIC 37 starts the power delivery of the output power changed by the processing at S11 (S17). The USBPDIC 37 returns the processing to S9.

For example, in the processing at S17, when it is possible to continue the power delivery of the output power started by the processing at S7, the power delivery of that output power is maintained. For example, when the output power (15 W) corresponding to the category “PDO 1” is being delivered from the start of the power delivery to the tablet PC 5, the USBPDIC 37 maintains the setting of the category “PDO 1”. Thus, the power delivery unit 8 maintains the power delivery of the output power equivalent to 15 W in the processing at S17.

On the other hand, a case is assumed in which the output power (15 W) corresponding to “PDO 1” is being delivered at the start of the power delivery of the output power by the processing at S7. Here, when the remaining charge of the battery 11 of the printer 1 is determined, by the monitoring at S9, to be in a range of 40% to 60%, the USBPDIC 37 sets the category “PDO 2”. As a result of this, the power delivery unit 8 can perform power delivery of the output power equivalent to 10 W. Further, the output power is set in a similar manner when the remaining charge of the battery 11 is in a range of 20% to 40%, or in the range of 0% to 20%. In other words, the power delivery unit 8 lowers the output power in accordance with the decrease in the monitored remaining charge of the battery 11.

On the other hand, when it is determined that the negotiation has failed (no at S15), when it is determined that the output power required by the tablet PC 5 cannot be delivered, for example, the USBPDIC 37 sets the power delivery of the output power from the power delivery unit 8 to the tablet PC 5 to not possible (S19). In this case, the USBPDIC 37 turns the FET 36 off. The USBPDIC 37 returns the processing to S1.

Next, the case in which the AC adaptor 9 is connected to the printer 1 will be described. In this case, the battery 11 is charged by the power of the AC adaptor 9. Thus, the remaining charge of the battery 11 increases with the passage of time. Note that power is delivered from the battery 11 to the digital circuit unit 6, the printing unit 7, the power delivery unit 8, and the like.

As shown in FIG. 3, the USBPDIC 37 performs the processing from S1 to S5, at S7, and at S19 in a similar manner to that described above. The USBPDIC 37 monitors the remaining charge of the battery 11 (S9). The USBPDIC 37 changes the output power to the tablet PC 5 in accordance with the monitored remaining charge of the battery 11 (S11). In this case, the USBPDIC 37 refers to the power data object (PDO) shown in FIG. 4 and increases the output power in accordance with the increase in the monitored remaining charge of the battery 11. For example, when the remaining charge of the battery 11 has increased from the range of 20% to 40% (the category “PDO 3”) to the range of 40% to 60% (the category “PDO 2”), the USBPDIC 37 can increase the output power from 7.5 W (the category “PDO 3”) to 10 W (the category “PDO 2”).

Subsequently, the USBPDIC 37 performs the processing at S13 to S17, and at S19. The processing at S13 to S17, and at S19 is the same as the processing when the AC adaptor 9 is not connected to the printer 1.

As described above, the USBPDIC 37 monitors the remaining charge of the battery 11 after starting the power delivery of the output power to the tablet PC 5 by the power delivery unit 8. The USBPDIC 37 changes the output power to the tablet PC 5 in accordance with the monitored remaining charge of the battery 11.

The printer 1 can appropriately control the power delivery of the output power to the tablet PC 5 by changing the output power in accordance with a fluctuation in the remaining charge of the battery 11. Thus, the printer 1 can secure the power required for printing even when the remaining charge of the battery 11 fluctuates after the start of the power delivery to the tablet PC 5.

The USBPDIC 37 can decrease the output power in accordance with the decrease in the monitored remaining charge of the battery 11. The printer 1 can secure the power required for the printing while securing the output power to the tablet PC 5, by decreasing the output power in accordance with the decrease in the remaining charge of the battery 11.

The battery 11 is charged by the power of the AC adaptor 9. When the battery 11 is being charged by the power of the AC adaptor 9, the USBPDIC 37 increases the output power in accordance with the increase in the monitored remaining charge of the battery 11. When the remaining charge of the battery 11 has increased due to being charged, the printer 1 can increase the output power to the tablet PC 5 while securing the power required for the printing.

The power delivery unit 8 performs the negotiation with the tablet PC 5 in compliance with the USB power delivery (USB PD) standard. The power delivery unit 8 performs the power delivery of the output power to the tablet PC 5 based on the negotiation result. The printer 1 can perform the power delivery of the output power to the tablet PC 5 in compliance with the USB power delivery (USB PD) standard.

The storage unit 37A stores the power data object (PDO) indicating the output power that the power delivery unit 8 can deliver in accordance with the remaining charge of the battery 11. The USBPDIC 37 refers to the power data object (PDO) stored in the storage unit 37A, and changes the output power in accordance with the remaining charge of the battery 11. Using the power data object (PDO), the printer 1 can perform more detailed control of the power delivery of the output power.

The OR circuit 32 switches the power delivery path to the tablet PC 5 in accordance with the presence or absence of the connection with the AC adaptor 9. When the AC adaptor 9 is connected, the OR circuit 32 switches the power delivery path so as to perform the power delivery from the power of the AC adaptor 9. Thus, when the AC adaptor 9 is connected, the printer 1 can perform the power delivery to the tablet PC 5 from the power of the AC adaptor 9.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

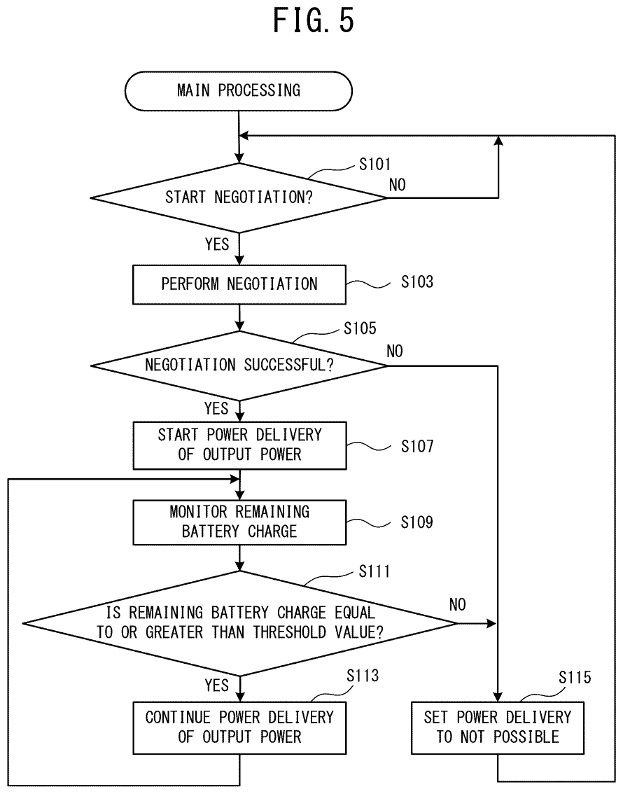

The main processing according to a modified example will be described with reference to FIG. 5. In the above-described embodiment, the output power is decided based on the remaining charge of the battery 11, by referring to the power data object (PDO) shown in FIG. 4. In contrast to this, in the main processing according to the modified example, a difference is that the power data object (PDO) is not referred to, and the viability of the power delivery is changed depending on a relationship between the remaining charge of the battery 11 and a threshold value.

When the main processing is started, the USBPDIC 37 determines whether or not to start negotiation with the tablet PC 5 (S101). For example, when the tablet PC 5 is not connected and it is determined that the negotiation is not to be started (no at S101), the USBPDIC 37 returns the processing to S101 and stands by. When the tablet PC 5 is connected and it is determined that the negotiation is to be started (yes at S101), the USBPDIC 37 performs the negotiation with the tablet PC 5 (S103).

The USBPDIC 37 determines whether or not the negotiation has been successful (S105). When it is determined that the negotiation has failed (no at S105), the USBPDIC 37 sets the power delivery of the output power from the power delivery unit 8 to not possible (S115). In this case, the USBPDIC 37 turns the FET 36 off.

When it is determined that the negotiation has been successful (yes at S105), the USBPDIC 37 starts the power delivery of the output power to the tablet PC 5 in accordance with the negotiation result (S107). In this case, the power delivery unit 8 performs the power delivery of the output power in accordance with the requirement of the tablet PC 5.

The USBPDIC 37 monitors the remaining charge of the battery 11 (S109). The USBPDIC 37 determines whether or not the monitored remaining charge of the battery 11 is equal to or greater than a predetermined threshold value (S111). Here, the threshold value is, for example, 30% of a maximum remaining charge of the battery 11. Note that the user may change the threshold value as appropriate, in accordance with a desired printing speed.

When it is determined that the remaining charge of the battery 11 is equal to or greater than the threshold value (yes at S111), the USBPDIC 37 continues the power delivery of the output power to the tablet PC 5 (S113). The USBPDIC 37 returns the processing to S109. On the other hand, when the remaining charge of the battery 11 is less than the threshold value (no at S111), the USBPDIC 37 sets the power delivery of the output power to the tablet PC 5 from the power delivery unit 8 to not possible (S115). The USBPDIC 37 returns the processing to S101.

Thus, the printer 1 can secure the power required for the printing, by stopping the power delivery of the output power to the tablet PC 5.

The present disclosure is not limited to the above-described embodiment, and various further modifications are possible. The techniques disclosed in the above-described embodiment and modified example can be combined insofar as no contradictions arise. The printer 1 is the thermal type, but is not limited to this example, and an inkjet method may be adopted. The external device is the tablet PC 5, but is not limited to this example. For example, the external device may be a device such as a smartphone, a PC, or the like. The AC adaptor 9 is used as the external power supply, but the external power supply is not limited to this example. For example, the external power supply may be substituted by a battery or the like. The printer 1 may receive power in compliance with the USB power delivery (USB PD) standard of the external device.

In the above-described embodiment, the output power is changed by referring to power data object (PDO) shown in FIG. 4, but a configuration is not limited to this example. A number of the categories may be set to be fewer, or may be set to be more, in accordance with the remaining charge of the battery 11. Further, setting values of each of the categories may be changed as appropriate.

In the above-described embodiment, at S7 and S107 of the main processing, the output power required by the external device is delivered, but a configuration is not limited to this example. For example, the power delivery may be performed by monitoring the remaining charge of the battery 11 before the processing at S1, and delivering the output power corresponding to that remaining charge with reference to the power data object (PDO).

In the above-described embodiment, the power data object (PDO) is stored in the storage unit 37A of the USBPDIC 37, but a configuration is not limited to this example. For example, the power data object (PDO) may be stored in another storage medium, such as the flash memory 23, the EEPROM 24, or the like.

Note that, in place of the USBPDIC 37, a CPU, an ASIC, a field programmable gate array (FPGA), or the like may be used as the processor. Each of the steps of the main processing may be processed in a distributed manner by a plurality of processors. The printer 1 may be provided with another non-transitory storage medium, such as an HDD or the like, for example. It is sufficient that the non-transitory storage medium be a storage medium capable of saving information, regardless of a period of storage of the information. The non-transitory storage medium need not necessarily include a temporary storage medium (a transmission signal, for example).

Each of the various programs may be downloaded (that is, may be transmitted as transmission signals) from a server connected to a network (not shown in the drawings), for example, and may be stored in a memory such as an HDD or the like. In this case, each of the various programs may be stored in a non-transitory storage medium, such as an HDD or the like, provided in the server.

What is claimed is:

1. A printer configured to be driven by a battery, the printer comprising:
a printing unit configured to perform printing on a medium, based on a power of the battery;
a power delivery unit configured to deliver an output power to an external device, the output power being based on the power of the battery;
a processor; and
a memory storing computer-readable instructions that, when executed by the processor, perform processes comprising:
monitoring a remaining charge of the battery, after delivering the output power to the external device by the power delivery unit; and
changing the output power to the external device, in accordance with the monitored remaining charge of the battery.

2. The printer according to claim 1, wherein
the changing includes decreasing the output power in accordance with a decrease in the monitored remaining charge of the battery.

3. The printer according to claim 1, wherein
the battery is charged by a power of an external power supply, and
the changing includes increasing the output power in accordance with the monitored remaining charge of the battery, when the battery is being charged by the power of the external power supply.

4. The printer according to claim 1, wherein
the changing includes stopping to deliver the output power to the external device, when the monitored remaining charge of the battery is less than a threshold value.

5. The printer according to claim 1, wherein
the computer-readable instructions, when executed by the processor, further instruct the printer to perform processes comprising:
causing the power delivery unit to perform negotiation with the external device in compliance with a USB power delivery (USB PD) standard; and
causing the power delivery unit to deliver the output power to the external device, in accordance with a result of the negotiation.

6. The printer according to claim 5, further comprising:
a storage unit storing a power data object (PDO), the power data object indicating the output power to be delivered from the power delivery unit in accordance with the remaining charge of the battery, wherein
the changing includes:
referring to the power data object (PDO) stored in the storage unit; and
changing the output power to corresponding one in the power data object (PDO) in accordance with the monitored remaining charge of the battery.

7. The printer according to claim 5, further comprising:
an OR circuit configured to switch a power delivery path to the external device in accordance with a presence or absence of a connection to an external power supply, wherein
the computer-readable instructions, when executed by the processor, further instruct the printer to perform a process comprising:
causing, when the external power supply is connected, the OR circuit to switch the power delivery path to deliver the output power, based on a power of the external power supply, to the external device from the power delivery unit.
